(19) United States
(12) Patent Application Publication
(10) Pub. No.: US 2023/0003046 A1
(43) Pub. Date: Jan. 5, 2023

(54) WIND TURBINE AND METHOD FOR MANUFACTURING A WIND TURBINE TOWER

(71) Applicant: Wobben Properties GmbH, Aurich (DE)

(72) Inventor: Roy Kersten, Hohenwarthe (DE)

(21) Appl. No.: 17/855,622

(22) Filed: Jun. 30, 2022

(30) Foreign Application Priority Data
Jul. 1, 2021 (EP) 21183011.2

(51) Int. Cl. E04H 12/12; E04H 12/08

(52) U.S. Cl. CPC E04H 12/12; E04H 12/08

(57) ABSTRACT

A wind turbine with a tower is provided, which has at least one first and second tower segment. The first tower segment has a steel wall and at least one first opening in the steel wall. Further provided is a reinforcing element with a cured casting compound around an area of the first opening.

### BACKGROUND

### Technical Field

The present invention relates to a wind turbine as well as to a method for manufacturing a wind turbine tower.

### Description of the Related Art

The towers of a wind turbine typically have a doorway in the lower tower segment, so that service personnel can enter the wind turbine. To this end, an opening must be present in the wall of a lower tower segment. In tower segments made out of steel, doorframes or reinforced doorplates are welded on or in. This is necessary because each opening in a tower segment leads to a mechanical weakening of the tower segment. However, welding on or in doorframes or reinforced doorplates is complicated and cost-intensive.

### BRIEF SUMMARY

Provided is a wind turbine as well as a method for manufacturing a tower of a wind turbine, in which openings can be provided in the tower wall, which reduces a weakening of a tower segment and is cost-effective.

As a consequence, a wind turbine with a tower is provided, which has at least one first and second tower segment. The tower segment has a steel wall and at least one opening in the steel wall. Further provided is at least one reinforcing element with a cured casting compound around an area of the first opening.

An opening can thus be provided in a wall of a steel tower segment. In order to improve the stability of the steel tower segment, a reinforcing element with a cured casting compound is provided around the first opening. This makes it possible to improve the way doorframes or doorplates are secured to the steel wall, so as to achieve an improved strength of the tower segment.

In one aspect of the present invention, the reinforcing element has tooth elements, which are fastened to the wall inside. In addition, the reinforcing element has the cured casting compound on the wall inside around the first opening. The tooth elements protrude into the cured casting compound.

In another aspect of the present invention, the reinforcing element has reinforcing bars for reinforcement purposes.

The invention also relates to a method for manufacturing a wind turbine tower. A tower segment with a steel wall and a first opening is formed. Tooth elements are fastened to the steel wall around the first opening. A shell is provided around the opening. The tooth elements protrude into the volume that is surrounded by the formwork. Casting compound is filled into the formwork and cured.

Additional embodiments of the invention are the subject of the subclaims.

### BRIEF DESCRIPTION OF THE SEVERAL VIEWS OF THE DRAWINGS

Advantages and exemplary embodiments of the invention will be described in more detail below with reference to the drawing.

FIG. 1 shows an illustration of a wind turbine according to an exemplary embodiment of the invention,

FIG. 2 shows a cutout of a sectional view of a tower segment of the wind turbine on FIG. 1, and

FIG. 3 shows a schematic top view of a doorway in a wall of a tower segment of the wind turbine on FIG. 1.

### DETAILED DESCRIPTION

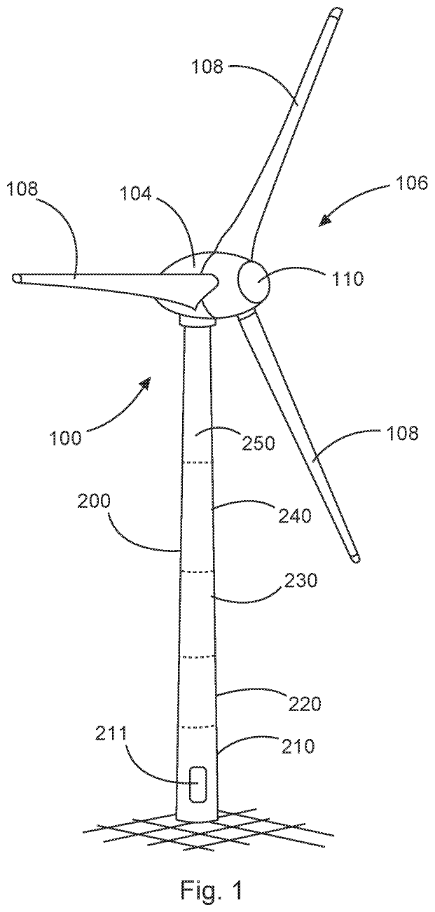

FIG. 1 shows an illustration of a wind turbine according to an exemplary embodiment of the invention. The wind turbine 100 has a tower 200, which is composed of several tower segments 210, 220, 230, 240, and 250. Provided on the tower 200 is a nacelle 104 as well as an aerodynamic rotor 106 with a spinner 110 and three rotor blades 108. Provided inside of the nacelle 104 is an electrical generator, which is directly or indirectly connected with the aerodynamic rotor 106 and can generate electrical energy.

A first tower segment or a first tower section 210 has a steel wall and an opening 211. The other tower segments 220-250 can optionally also have openings. For example, the opening 211 can constitute a doorway in the first tower segment 210.

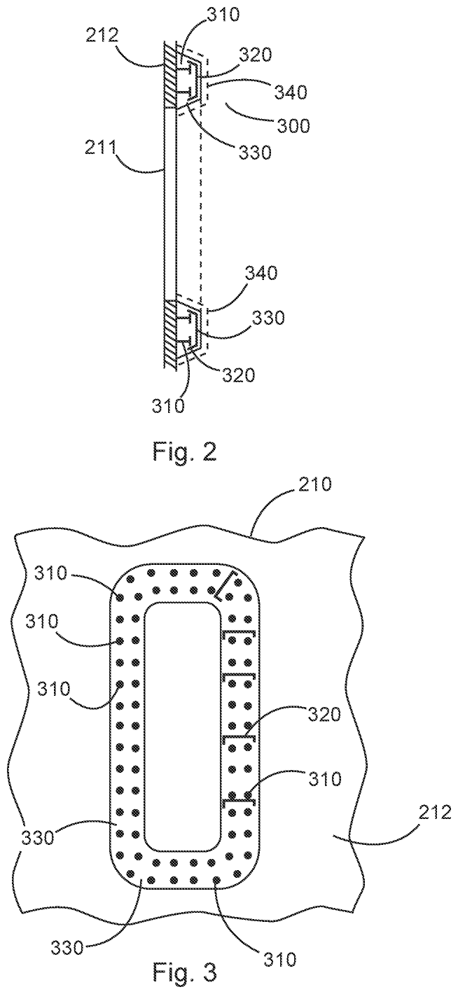

FIG. 2 shows a cutout of a sectional view of a tower segment of the wind turbine on FIG. 1. The lower tower segment 210 has a steel wall 212 as well as an opening 211 in the wall 212. For example, the opening 211 can constitute a doorway. A reinforcing element 300 is provided to improve the mechanical stiffness of the steel wall 212 in the area of the opening 211. To this end, a plurality of tooth elements 310 is provided around the opening 211 on an interior side of the steel wall 212. For example, the tooth elements 310 can constitute head bolt dowels, which can be fastened (for example, welded) to the interior side of the wall 212. Reinforcing bars 320 can optionally be provided in the area of the tooth elements 310 before providing a casting compound 330. This serves to improve the mechanical stiffness of the reinforcing element 300.

As a consequence, the reinforcing element 300 has the tooth elements 310, and optionally the reinforcing bars 320 and the casting compound 330.

FIG. 3 shows a schematic top view of a doorway in a wall of a tower segment of the wind turbine on FIG. 1. A reinforcing element or stiffening element 300 is provided around the doorway 210 (preferably on the interior side of the wall 212). The reinforcing element 300 has tooth elements 310, which are fastened, in particular welded, to the steel wall 212.

In order to manufacture the reinforcing element 300, the tooth elements 310 can be welded to the steel wall 212. Reinforcing bars 320 can then optionally be provided. A formwork 340 can thereafter be provided around the opening 210, after which a casting compound 330 can be filled into the formwork 340. After setting or curing the casting compound 330, the formwork 340 can optionally be removed. The casting compound 330 can be in-situ concrete or a grouting agent, e.g., such as Pagel.

As a consequence, the reinforcing element can constitute a reinforcing ring or stiffening ring made out of cured casting compound, which are fastened to a steel wall via head bolts (dowels), and arranged around the opening.

### REFERENCE LIST

100 Wind turbine
104 Nacelle
106 Aerodynamic rotor
108 Rotor blades
200 Tower
210 First tower segment/tower section
211 Doorway (opening)
212 Tower wall
220 Second tower segment/tower section
230 Third tower segment/tower section
240 Fourth tower segment/tower section
250 Fifth tower segment/tower section
300 Reinforcing element
310 Tooth elements
320 Reinforcing bars
330 Casting compound
340 Formwork

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wind turbine, comprising:
a tower having first and second tower segments,
wherein the first tower segment has:
a steel wall,
at least one opening, and
at least one reinforcing element including a cured casting compound around an area of the at least one opening.

2. The wind turbine according to claim 1, wherein the at least one reinforcing element has a plurality of tooth elements fastened to an interior side of the steel wall,
wherein the cured casting compound on the steel wall is at the interior side of the steel wall and around the at least one opening, and
wherein the plurality of tooth elements protrude into the cured casting compound.

3. The wind turbine according to claim 1, wherein the at least one reinforcing element has a plurality of reinforcing bars for reinforcing the at least one reinforcing element.

4. The wind turbine according to claim 1, comprising a plurality of second tower segments.

5. A wind turbine tower, comprising:
a plurality of tower segments including a first tower segment and a second tower segment,
wherein the first tower segment has:
a steel wall,
at least one opening, and
at least one reinforcing element including a cured casting compound around an area of the at least one opening.

6. A method for manufacturing a wind turbine tower, the method comprising:
forming a tower segment with a steel wall and an opening in the steel wall,
fastening a plurality of tooth elements to the steel wall around the opening,
providing a formwork around the opening, wherein the plurality of tooth elements protrude into a volume that is surrounded by the formwork,
filling casing compound into the formwork, and
curing the casting compound.
